(19) United States
(12) Patent Application Publication
(10) Pub. No.: US 2014/0055819 A1
(43) Pub. Date: Feb. 27, 2014

(54) IMAGE PROCESSING APPARATUS, METHOD, AND COMPUTER-READABLE MEDIUM

(71) Applicant: FUJI XEROX CO., LTD., Tokyo (JP)

(72) Inventors: Kota MATSUO, Kanagawa (JP); Toru MISAIZU, Kanagawa (JP); Kenji HARA, Kanagawa (JP); Shigeru ARAI, Kanagawa (JP)

(73) Assignee: FUJI XEROX CO., LTD., Tokyo (JP)

(21) Appl. No.: 13/743,048

(22) Filed: Jan. 16, 2013

(30) Foreign Application Priority Data
Aug. 27, 2012 (JP) 2012-186485

(51) Int. Cl. H04N 1/405

(52) U.S. Cl. CPC H04N 1/40018
USPC 358/3.06

(57) ABSTRACT

An image processing apparatus includes memory that stores first pixel values in association with second pixel values for respective droplets which have been classified into multiple types according to size, one or more converters that convert pixel values in a received image, which correspond to the first pixel values, into second pixel values to generate an image for each of the respective droplet types, on the basis of the correspondences between the first pixel values and the second pixel values stored in the memory, a screening unit that screens the images for the respective droplet types converted by the one or more converters, and a compositing unit that composites the images for the respective droplet types screened by the screening unit.

### CROSS-REFERENCE TO RELATED APPLICATIONS

This application is based on and claims priority under 35 USC 119 from Japanese Patent Application No. 2012-186485 filed Aug. 27, 2012.

### BACKGROUND

(i) Technical Field

The present invention relates to an image processing apparatus, an image processing method, and a computer-readable medium.

(ii) Related Art

PTL 1 takes as its goal to provide technology that creates multi-valued image data able to realize wider tone expression. PTL discloses comparing AM halftone-forming SPD (screen pattern data, i.e., threshold matrix data used in halftone processing) to an original image and generating binary image matrix data indicating whether or not to form pixels with small dots, comparing FM halftone-forming SPD to an original image and generating binary image matrix data indicating whether or not to form pixels with medium dots, comparing FM halftone-forming SPD to an original image and generating binary image matrix data indicating whether or not to form pixels with large dots, and on the basis of the three sets of binary image matrix data thus obtained, generating multi-valued halftone image data that indicates whether or not to form pixels, and if so, which sizes of dots to use for forming pixels.

### CITATION LIST

### Patent Literature

[PTL 1] Japanese Unexamined Patent Application Publication No. 2011-029979

### SUMMARY

It is an object of the present invention to provide an image processing apparatus, an image processing method, and an image processing program configured to combine multiple types of droplets without using multiple screens.

The principal matter of the present invention for achieving such an object resides in the following aspects.

According to the first aspect, there is provided an image processing apparatus including storing means for storing first pixel values in association with second values for respective droplets which have been classified into a plurality of types according to size, one or more converting means for converting pixel values in a received image, which correspond to the first pixel values, into second pixel values to generate an image for each of the respective droplet types, on the basis of the correspondences between the first pixel values and the second pixel values stored in the storing means, screening means for screening the images for the respective droplet types converted by the one or more converting means, and compositing means for compositing the images for the respective droplet types screened by the screening means.

According to the second aspect, the image processing apparatus according to the first aspect may further include correspondence generating means for generating correspondences between the first pixel values and the second pixel values from values indicating the proportion of each droplet type to use with respect to the first pixel values, and storing the generated correspondences in the storing means.

According to the third aspect, the correspondence generating means in the image processing apparatus according to the second aspect may receive a variable indicating whether or not to allocate more droplets with smaller sizes than other droplets with respect to low pixel values in the received image, and generate correspondences between the first pixel values and the second pixel values in accordance with the variable.

According to the fourth aspect, the correspondence generating means in the image processing apparatus according to the second aspect may receive a variable indicating whether or not to allocate more droplets with smaller sizes than other droplets with respect to high pixel values in the received image, and generate correspondences between the first pixel values and the second pixel values in accordance with the variable.

According to the fifth aspect, there is provided an image processing method that includes storing first pixel values in association with second values for respective droplets which have been classified into a plurality of types according to size, converting pixel values in a received image, which correspond to the first pixel values, into second pixel values to generate an image for each of the respective droplet types, on the basis of the stored correspondences between the first pixel values and the second pixel values, screening the converted images for the respective droplet types, and compositing the screened images for the respective droplet types.

According to the sixth aspect, there is provided an image processing program causing a computer to function as storing means for storing first pixel values in association with second values for respective droplets which have been classified into a plurality of types according to size, one or more converting means for converting pixel values in a received image, which correspond to the first pixel values, into second pixel values to generate an image for each of the respective droplet types, on the basis of the correspondences between the first pixel values and the second pixel values stored in the storing means, screening means for screening the images for the respective droplet types converted by the one or more converting means, and compositing means for compositing the images for the respective droplet types screened by the screening means.

### Advantageous Effects of Invention

According to the image processing apparatus in accordance with the first aspect, it is possible to combine multiple types of droplets without using multiple screens.

According to the image processing apparatus in accordance with the second aspect, it is possible to combine multiple types of droplets in specified proportions without using multiple screens.

According to the image processing apparatus in accordance with the third aspect, it is possible to generate correspondences between first pixel values and second pixel values by specifying a variable indicating whether or not to allocate more droplets with smaller sizes than other droplets with respect to low pixel values in a received image.

According to the image processing apparatus in accordance with the fourth aspect, it is possible to generate correspondences between first pixel values and second pixel values by specifying a variable indicating whether or not to allocate more droplets with smaller sizes than other droplets with respect to high pixel values in a received image.

According to the image processing method in accordance with the fifth aspect, it is possible to combine multiple types of droplets without using multiple screens.

According to the image processing program in accordance with the sixth aspect, it is possible to combine multiple types of droplets without using multiple screens.

### BRIEF DESCRIPTION OF THE DRAWINGS

An exemplary embodiment of the present invention will be described in detail based on the following figures, wherein:

FIG. 1 is a schematic module configuration diagram for an exemplary configuration according to an exemplary embodiment;

FIG. 2 is a schematic module configuration diagram for an exemplary configuration according to an exemplary embodiment;

FIG. 3 is a flowchart illustrating an exemplary process according to an exemplary embodiment;

FIGS. 4A and 4B are diagrams illustrating exemplary conversion tables;

FIG. 5 is a diagram illustrating an example of a halftone matrix;

FIG. 6 is a diagram illustrating an example of an image;

FIGS. 7A and 7B are diagrams illustrating examples of a small droplet intermediate image and a small droplet output image;

FIGS. 8A and 8B are diagrams illustrating examples of a medium droplet intermediate image and a medium droplet output image;

FIGS. 9A and 9B are diagrams illustrating examples of a large droplet intermediate image and a large droplet output image;

FIG. 10 is a diagram illustrating an example of an output image;

FIG. 11 is a diagram illustrating an example of combining two types of droplets according to an exemplary embodiment;

FIG. 12 is a diagram illustrating an example of combining multiple types of droplets according to an exemplary embodiment;

FIG. 13 is a graph illustrating exemplary changes in pixel values in the case of printing with one type of droplet;

FIG. 14 is a graph illustrating exemplary changes in pixel values in the case of printing with multiple types of droplets;

FIGS. 15A to 15E are diagrams illustrating correspondences according to different droplet size selection instructions, and exemplary image processing;

FIGS. 16A to 16E are diagrams illustrating correspondences according to different droplet size selection instructions, and exemplary image processing;

FIGS. 17A to 17E are diagrams illustrating correspondences according to different droplet size selection instructions, and exemplary image processing;

FIG. 18 is a diagram illustrating an example for the case of expressing an image with three types of droplets;

FIG. 19 is a diagram illustrating an example for the case of expressing an image with two types of droplets;

FIG. 20 is a graph illustrating exemplary changes in pixel values according to an exemplary embodiment;

FIG. 21 is a block diagram illustrating an exemplary hardware configuration of a computer that realizes an exemplary embodiment;

FIGS. 22A to 22C are diagrams illustrating an example of a halftone matrices for respective droplets;

FIG. 23 is a diagram illustrating an exemplary relationship between density and halftone surface area ratio;

FIG. 24 is a diagram illustrating an example of combining various types of droplets;

FIGS. 25A to 25D are diagrams illustrating an example of generating halftone matrices for respective droplets from a basic halftone matrix;

FIGS. 26A to 26F are diagrams illustrating an example of screening; and

FIG. 27 is a graph illustrating exemplary changes in pixel values according to the related art.

### DETAILED DESCRIPTION

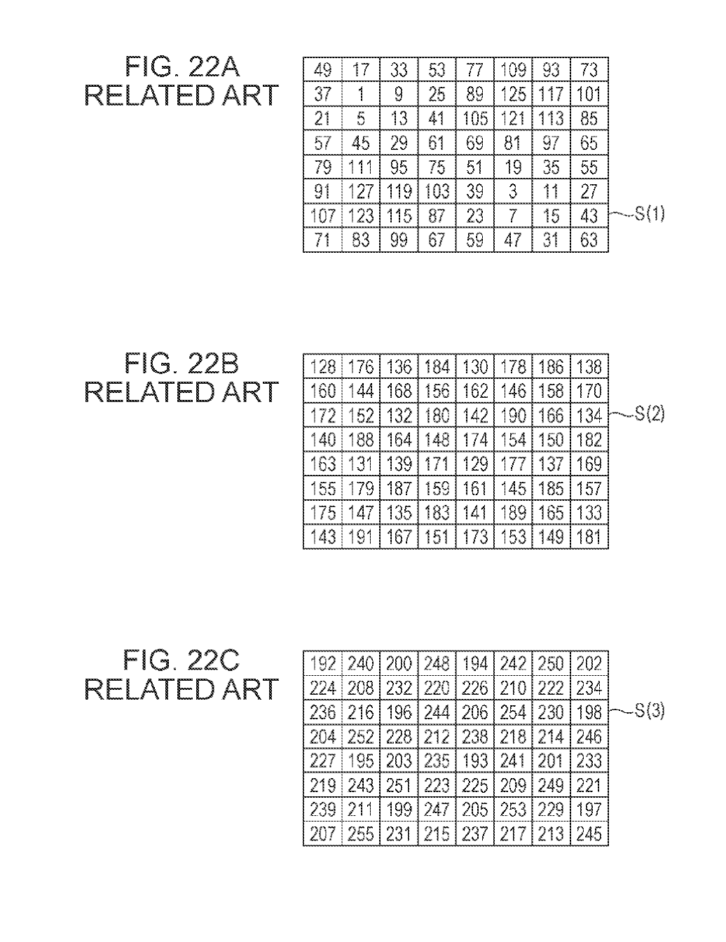

First, before describing the exemplary embodiment, an image processing apparatus will be described using the examples in FIGS. 22A to 27 as a premise thereto. Note that this description is intended to aid comprehension of the exemplary embodiment.

There exists a printing apparatus able to form pixels using N types (where N is a natural number equal to or greater than 2) of differently sized droplets (dots). The printing apparatus herein refers to an apparatus that prints an image by ejecting ink droplets from a print head, and is commonly called an inkjet printer.

Additionally, among inkjet printers, there exists an apparatus equipped with a head that enables pixel formation (plotting) with differently sized droplets (dots) in which the amount of ink ejected onto the print medium is varied among multiple levels (i.e., a multi-value head). Specific modes for varying the amount of ejected ink include a technique that varies the ink droplet size by modulating the head's driving waveform and voltage, and a technique that varies the number of simultaneous ejections of fixed-size ink droplets.

With a printing apparatus able to form pixels with multiple types of differently sized droplets like an inkjet printer equipped with a multi-value head, it is possible to form a halftone image expressed by multiple values (i.e., a multi-value halftone image) on a print medium. For example, in the case of an inkjet printer equipped with a head able to form pixels with three types of differently sized droplets (small droplets, medium droplets, and large droplets), it is possible to form an image on a print medium with halftone image data (multi-valued halftone image data) expressed with multiple tones (herein, tone levels from 0 to 3). In other words, in this case, an inkjet printer forms pixels with large droplets at positions where the multi-valued halftone image data is “3”, for example, forms pixels with medium droplets at positions where the multi-valued halftone image data is “2”, for example, and forms pixels with small droplets at positions where the multi-valued halftone image data is “1”, for example. Meanwhile, the inkjet printer does not form pixels at positions where the multi-valued halftone image data is “0”. Thus, the multi-valued halftone image data is formed as an image on a print medium.

There are various halftoning techniques. For example, there exists a halftoning technique that expresses tones by varying the sizes of halftone dots arrayed in a lattice (AM halftoning). As another example, there also exists a halftoning technique that expresses tones by varying the distribution (number) of halftone dots rather than their size (FM halftoning).

In Japanese Unexamined Patent Application Publication No. 2011-029979, N types of dots are switched out according to the following method in a printing apparatus that forms a multi-valued image by switching out N types of differently sized dots. For example, take N=3, with the three types being differentiated by size as small droplets, medium droplets, and large droplets, and with tones being 8-bit (i.e., Cin, the pixel value for a target pixel, or in other words grayscale information, has 256 levels from 0 to 255).

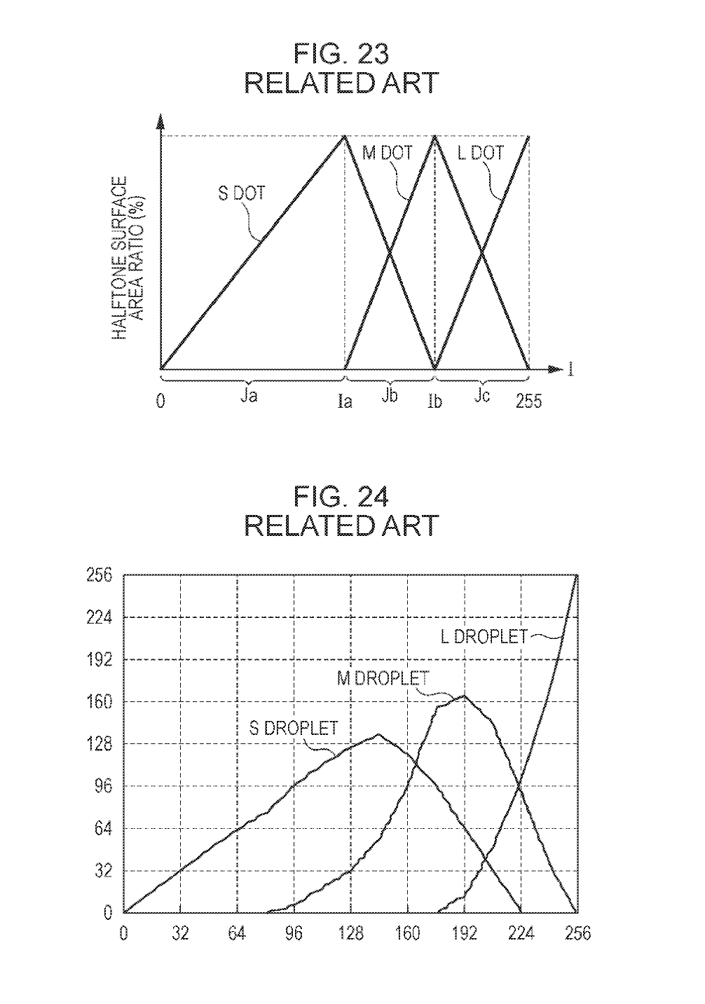

As illustrated by the example in FIG. 23, first the small droplets are increased from 0% to 100%. After the small droplets reach 100%, the medium droplets are increased from 0% to 100% while the small droplets are decreased proportionately. Once the medium droplets reach 100%, the large droplets are increased from 0% to 100% while the medium droplets are decreased proportionately. Finally, the large droplets reach 100%.

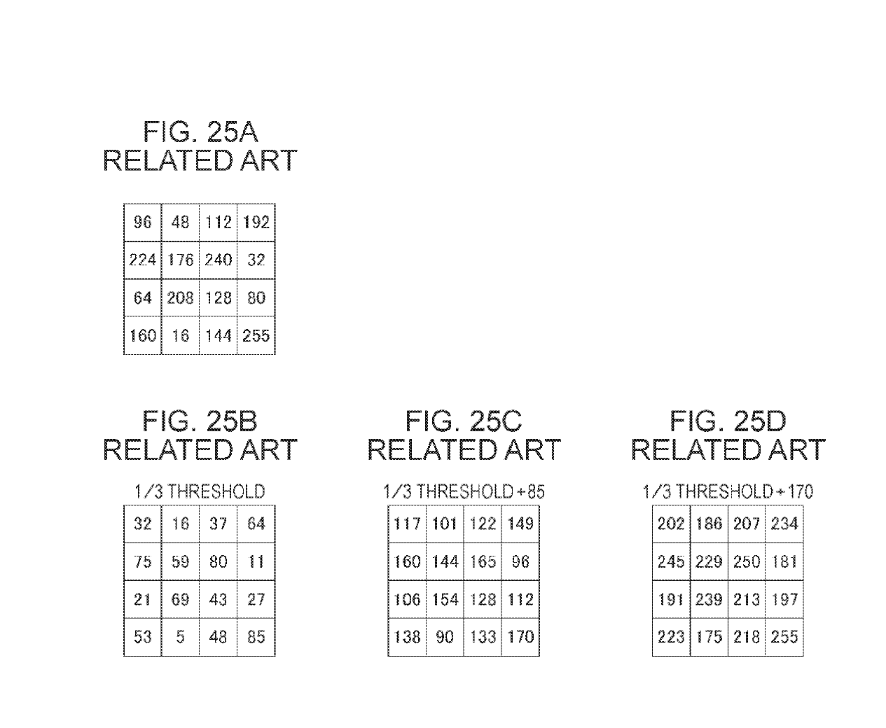

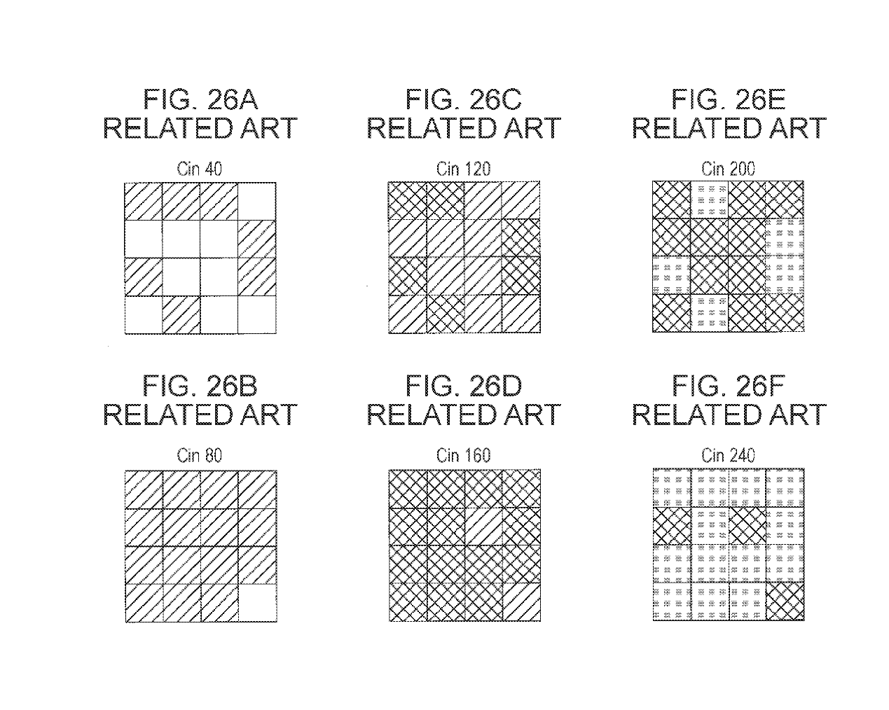

An example of a specific processing method will be illustrated. First, the basic halftone matrix illustrated by the example in FIG. 25A is used as a basis to generate three halftone matrices: a small droplet halftone matrix illustrated by the example in FIG. 25B (at ⅓ the threshold of the basic halftone matrix), a medium droplet halftone matrix illustrated by the example in FIG. 25C (at the small droplet threshold plus 85), and a large droplet halftone matrix illustrated by the example in FIG. 25D (at the small droplet threshold plus 170). The processing results for respectively corresponding values of Cin are illustrated by the examples in FIGS. 26A to 26F. Herein, diagonally shaded pixels represent image formation with small droplets, cross-hatched pixels represent image formation with medium droplets, and smoothly shaded gray pixels represent image formation with large droplets. The result is a combination of empty pixels and small droplets for Cin values up to 85 (FIGS. 26A and 26B), small droplets and medium droplets for Cin values from 86 to 170 (FIGS. 26C and 26D), and medium droplets and large droplets for Cin values from 171 to 255 (FIGS. 26E and 26F). Since the total for each droplet does not exceed 100%, there are 256×3=768 combinations that may be realized.

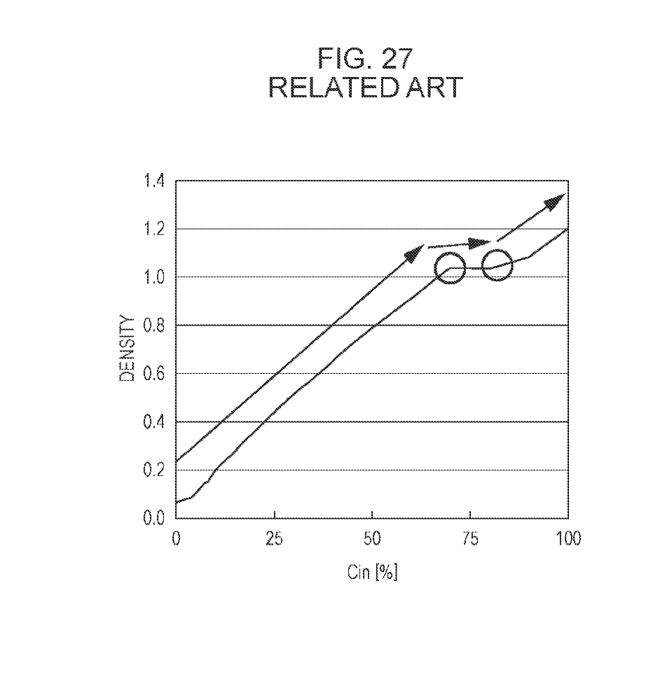

With such a processing method, it may be difficult to adjust the tone differentiation among the respective droplets in some cases. Tone differentiation includes tone differentiation among small, medium, and large droplets individually, as well as tone balances when combining droplets. As an example of cases where tone differentiation is difficult, tone jumps and tone loss frequently occur at droplet switch points (expressed in terms of the previous example, the point of switching from small droplets only to the addition of medium droplets, and the point of switching from medium droplets only to the addition of large droplets). FIG. 27 is a graph illustrating an example of this relationship, with the horizontal axis representing the tone value of a received image, and the vertical axis representing the output density. As illustrated in FIG. 27, although density rises linearly until the region enclosed by the circle to the left, after that tone loss is seen before the original rising slope resumes after the region enclosed by the circle on the right.

Although there do exist methods that arbitrarily combine tones applying respective droplets in order to mitigate the above issues, as illustrated in FIG. 24, for example, realizing these methods is difficult with current technology. For example, with the configuration in Japanese Unexamined Patent Application Publication No. 2011-029979 (see the example in FIGS. 22A to 22C), the individual pixels for respective droplets plot (i.e., form an image) with a Cin defined from 0 to 255. Herein, FIGS. 22A to 22C illustrate examples of threshold matrix data used in AM halftoning. The halftone matrix illustrated by the example in FIG. 22A includes multiple tone values within the threshold range of 0 to 127, while the halftone matrix illustrated in FIG. 22B includes multiple tone values within the threshold range of 128 to 191, and the halftone matrix illustrated by the example in FIG. 22C includes multiple tone values within the threshold range of 192 to 255. This is because there is a restriction in that deplotted pixels are made proportional to the plotted pixels for larger droplets, and attempting to realize arbitrary combinations with an extension of this configuration involves preparing a number of halftone matrices equal to the number of tones. For example, if applied to an image with 8 bits per pixel, the number of halftone matrices becomes 256 (tones).

Hereinafter, an exemplary embodiment related to realizing the present invention will be described by way of example on the basis of the drawings.

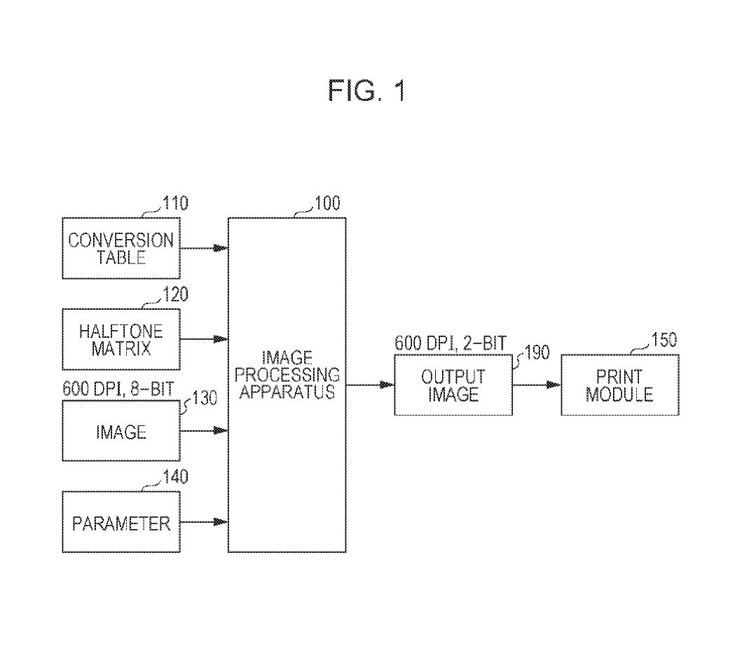

FIG. 1 illustrates a schematic module configuration for an exemplary configuration according to the exemplary embodiment.

Note that the term module refers to software (i.e., a computer program) or hardware components which are typically capable of being logically separated. Consequently, the term module in the exemplary embodiment not only refers to modules in a computer program, but also to modules in a hardware configuration. Thus, the exemplary embodiment also serves as a description of a computer program (a program that causes a computer to execute respective operations, a program that causes a computer to function as respective units, or a program that causes a computer to realize respective functions), a system, and a method for inducing functionality as such modules. Note that although terms like “store” and “record” and their equivalents may be used in the description for the sake of convenience, these terms mean that a storage apparatus is made to store information or that control is applied to cause a storage apparatus to store information in the case where the exemplary embodiment is a computer program. Also, while modules may be made to correspond with function on a one-to-one basis, some implementations may be configured such that one program constitutes one module, such that one program constitutes multiple modules, or conversely, such that multiple programs constitute one module. Moreover, multiple modules may be executed by one computer, but one module may also be executed by multiple computers in a distributed or parallel computing environment. Note that a single module may also contain other modules. Also, the term “connection” may be used hereinafter to denote logical connections (such as the transfer of data and referential relationships between instructions and data) in addition to physical connections. The term “predetermined” refers to something being determined prior to the processing in question, and obviously denotes something that is determined before a process according to the exemplary embodiment starts, but may also denote something that is determined after a process according to the exemplary embodiment has started but before the processing in question, according to conditions or states at that time, or according to conditions or states up to that time. In the case of multiple “predetermined values”, the predetermined values may be respectively different values, or two or more values (this obviously also includes the case of all values) which are the same. Additionally, statements to the effect of “B is conducted in the case of A” are used to denote that a determination is made regarding whether or not A holds true, and B is conducted in the case where it is determined that A holds true. However, this excludes cases where the determination of whether or not A holds true may be omitted.

Also, the terms “system” and “apparatus” not only encompass configurations in which multiple computers, hardware, or apparatus are connected by a communication medium such as a network (including connections that support 1-to-1 communication), but also encompass configurations realized by a single computer, hardware, or apparatus. The terms “apparatus” and “system” are used interchangeably. Obviously, the term “system” does not include mere, artificially arranged, social constructs (social systems).

Also, every time a process is conducted by each module or every time multiple processes are conducted within a module, information to be processed is retrieved from a storage apparatus, and the processing results are written back to the storage apparatus after the processing. Consequently, description of the retrieval from a storage apparatus before processing and the writing back to a storage apparatus after processing may be reduced or omitted in some cases. Note that the storage apparatus herein may include hard disks, random access memory (RAM), an auxiliary or external storage medium, storage apparatus accessed via a communication link, and registers, etc. inside a central processing unit (CPU).

An image processing apparatus according to the exemplary embodiment is able to form pixels using multiple types of differently sized droplets (particularly, three or more types of droplets in the exemplary embodiment). In order to enable the arbitrary combination of multiple droplets, an image processing apparatus 100 and a print module 150 are included, with the image processing apparatus 100 received a conversion table 110, a halftone matrix 120, an image 130, and a parameter 140, and outputting an output image 190, as illustrated by the example in FIG. 1. In other words, the conversion table 110, the halftone matrix 120, and the parameter 140 are used to convert the image 130 and generate the output image 190. For example, the image 130 may be a 600 dots per inch (dpi) image, with each pixel being expressed with 8 bits (i.e., 256 tones for Cin values from 0 to 255). The output image 190 may be a 600 dpi image, with each pixel being expressed with 2 bits. Note that an image with each pixel expressed with 2 bits refers to an image expressed with tone levels from 0 to 3 as discussed earlier. Subsequently, the print module 150 receives the output image 190 and conducts printing. In other words, the print module 150 uses multiple types of differently sized droplets to form the output image 190 on a print medium.

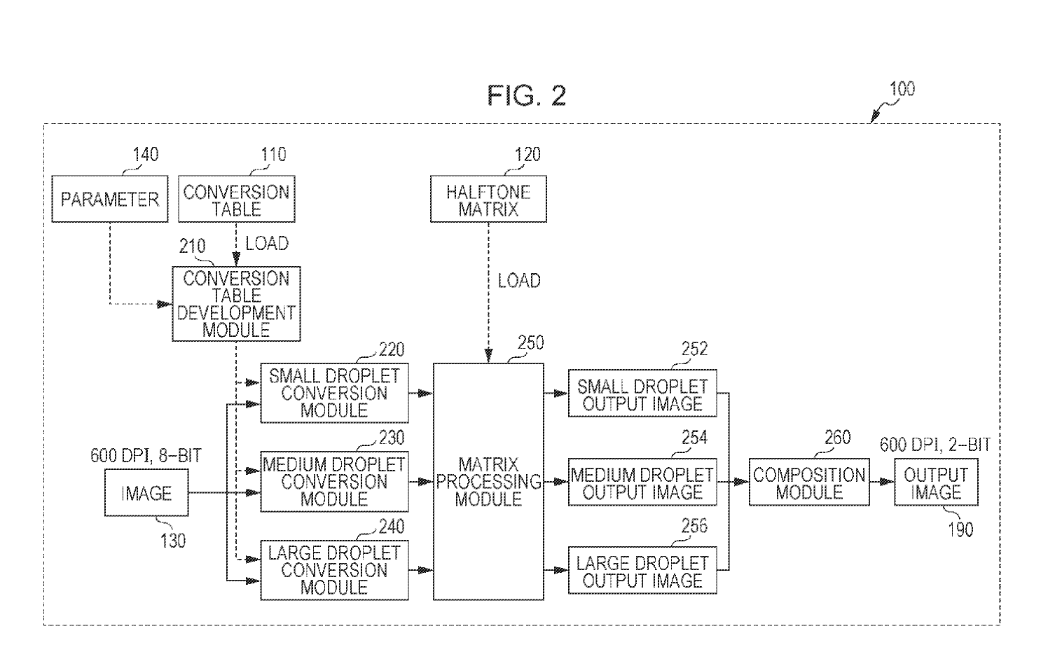

A detailed configuration of modules inside the image processing apparatus 100 will now be described using the example in FIG. 2. FIG. 2 is a schematic module configuration diagram for an exemplary configuration according to the exemplary embodiment. The solid arrows represent process flows related to the image processing itself, while the broken arrows represent process flows related to image preprocessing conducted before the image processing.

The image processing apparatus 100 includes a conversion table development module 210, a small droplet conversion module 220, a medium droplet conversion module 230, a large droplet conversion module 240, a matrix processing module 250, and a composition module 260.

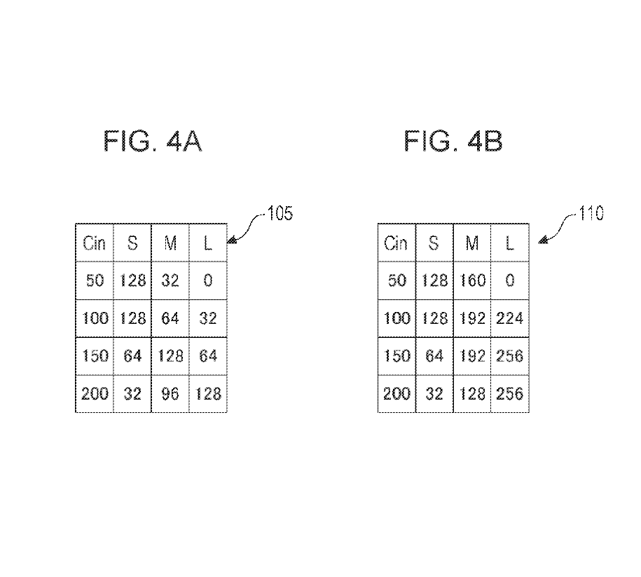

The conversion table 110 stores first pixel values in association with second pixel values (hereinafter also referred to as intermediate image pixel values) for respective droplets which have been classified into multiple types according to their size (hereinafter, the example of the three types of small droplets, medium droplets, and large droplets will be illustrated). The conversion table 110 illustrated in FIG. 4B is a relevant example. The Cin column corresponds to first pixel values, while the Small (S) column corresponds to second pixel values applying small droplets, the Medium (M) column to second pixel values applying medium droplets, and the Large (L) column to second pixel values applying large droplets. Note that in this example, the Cin column indicates ranges, with “50” representing values from 0 to 50, for example.

The conversion table development module 210 is connected to the small droplet conversion module 220, the medium droplet conversion module 230, and the large droplet conversion module 240. The conversion table development module 210 generates correspondences between first pixel values and second pixel values from values indicating proportions of droplets to use with respect to the first pixel values, and stores these correspondences in the conversion table 110. The conversion table 105 illustrated in FIG. 4A is a relevant example of values indicating proportions of droplets to use with respect to the first pixel values. The Cin column corresponds to first pixel values, while the Small (S) column corresponds to proportions applying small droplets, the Medium (M) column to proportions applying medium droplets, and the Large (L) column to proportions applying large droplets. Note that in this example, the Cin column indicates ranges, with “50” representing values from 0 to 50, for example. Also, the proportions represent proportions out of 256. For example, in the case where Cin is 100, the proportion of small droplets is taken to be 128 out of 256, the proportion of medium droplets to be 64 out of 256, and the proportion of large droplets to be 32 out of 256.

The conversion table development module 210 then sums the proportions in the small droplet column and the medium droplet column to generate pixel values for the medium droplet column in the conversion table 110. In the above example, 192 (the value of the medium droplet column for a Cin of 100 in the conversion table 110) is generated by taking 128+64. Also, the conversion table development module 210 sums the proportions in the small droplet column, the medium droplet column, and the large droplet column to generate pixel values for the large droplet column in the conversion table 110. In the above example, 224 (the value of the large droplet column for a Cin of 100 in the conversion table 110) is generated by taking 128+64+32.

Similarly, 128/160/0 is generated from the combination of 128/32/0, 128/192/224 is generated from the combination of 128/64/32, 64/192/256 is generated from the combination of 64/128/64, and 32/128/256 is generated from the combination of 32/96/128.

In addition, the conversion table development module 210 may also be configured to receive the parameter 140 and generate correspondences between first pixel values and second pixel values in accordance with the parameter 140, with the parameter 140 being a variable indicating whether or not to allocate more droplets with smaller sizes than other droplets with respect to low pixel values in the image being processed. Hereinafter, such variables indicating whether or not to allocate more droplets with smaller sizes than other droplets with respect to low pixel values in the image being processed may also be referred to as the droplet size selection A. The droplet size selection A prioritizes droplets in the order of small droplets, medium droplets, and large droplets. The example discussed above is an example of the case where the droplet size selection A is selected.

In addition, the conversion table development module 210 may also be configured to receive the parameter 140 and generate correspondences between first pixel values and second pixel values in accordance with the parameter 140, with the parameter 140 being a variable indicating whether or not to allocate more droplets with smaller sizes than other droplets with respect to high pixel values in the image being processed. Hereinafter, such variables indicating whether or not to allocate more droplets with smaller sizes than other droplets with respect to high pixel values in the image being processed may also be referred to as the droplet size selection B. The droplet size selection B prioritizes droplets in the order of large droplets, medium droplets, and small droplets, and is the reverse of the droplet size selection A.

Detailed processing in the case where the droplet size selection A and the droplet size selection B are selected will be discussed later.

The small droplet conversion module 220, the medium droplet conversion module 230, and the large droplet conversion module 240 respectively generate intermediate images from the image 130. FIG. 6 is a diagram illustrating an example of the image 130. A tone value (pixel value) is expressed for each pixel in the image. Obviously, FIG. 6 represents a portion of an image to be printed (i.e., an image portion equal in size to the halftone matrix 120).

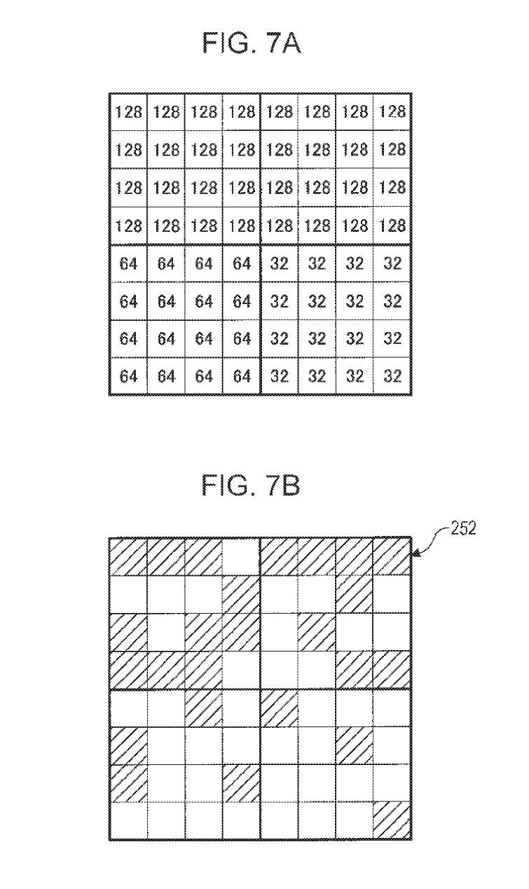

The small droplet conversion module 220 is connected to the conversion table development module 210 and the matrix processing module 250. The small droplet conversion module 220 converts pixel values in the image 130, which correspond to the first pixel values in the conversion table 110, into second pixel values for small droplets, on the basis of the correspondences between first pixel values and second pixel values stored in the conversion table 110. For example, the small droplet conversion module 220 may generate an intermediate image illustrated by the example in FIG. 7A from the image 130 on the basis of a conversion table 110 illustrated by the example in FIG. 4B. Specifically, tone values of 50 and 100 in the image 130 are converted into 128, while tone values of 150 are converted into 64 and tone values of 200 are converted into 32.

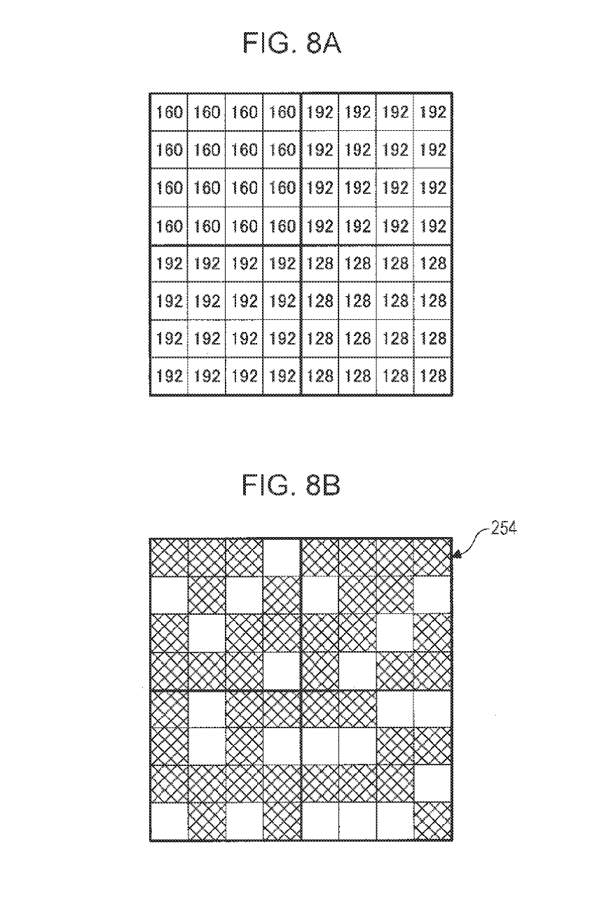

The medium droplet conversion module 230 is connected to the conversion table development module 210 and the matrix processing module 250. The medium droplet conversion module 230 converts pixel values in the image 130, which correspond to the first pixel values in the conversion table 110, into second pixel values for medium droplets, on the basis of the correspondences between first pixel values and second pixel values stored in the conversion table 110. For example, the medium droplet conversion module 230 may generate an intermediate image illustrated by the example in FIG. 8A from the image 130 on the basis of a conversion table 110 illustrated by the example in FIG. 4B. Specifically, tone values of 50 in the image 130 are converted into 160, while tone values of 100 and 150 are converted into 192 and tone values of 200 are converted into 128.

The large droplet conversion module 240 is connected to the conversion table development module 210 and the matrix processing module 250. The large droplet conversion module 240 converts pixel values in the image 130, which correspond to the first pixel values in the conversion table 110, into second pixel values for large droplets, on the basis of the correspondences between first pixel values and second pixel values stored in the conversion table 110. For example, the large droplet conversion module 240 may generate an intermediate image illustrated by the example in FIG. 9A from the image 130 on the basis of a conversion table 110 illustrated by the example in FIG. 4B. Specifically, tone values of 50 in the image 130 are converted into 0, while tone values of 100 are converted into 224 and tone values of 150 and 200 are converted into 256.

Note that since the respective droplets obey the conversion table 110, the number of valuations in an intermediate image is 256. However, since the total sum of droplets does not exceed 255, the total number of possibilities is the combination with repetition of the possible values 1 to 256 for each droplet type, for a total of 2,829,056 combinations.

Also, although the term “intermediate image” is used herein for convenience, the present process may be a dot-by-dot process (i.e., processing one pixel at a time) rather than pooling an entire image for processing, and thus it is sufficient for each droplet type to have one pixel's worth of intermediate information.

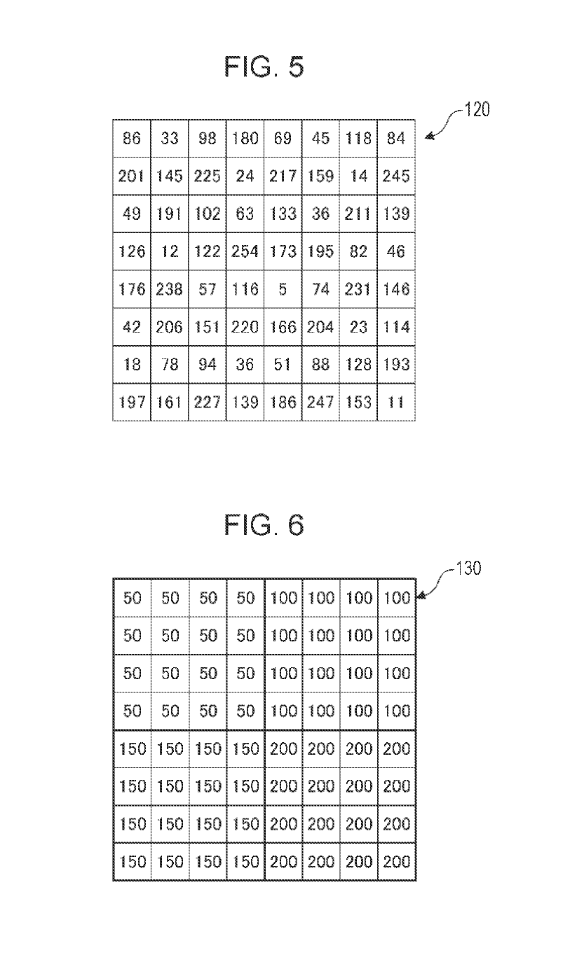

The matrix processing module 250 is connected to the small droplet conversion module 220, the medium droplet conversion module 230, the large droplet conversion module 240, and the composition module 260. The matrix processing module 250 screens the respective images for each droplet type converted by the small droplet conversion module 220, the medium droplet conversion module 230, and the large droplet conversion module 240 (i.e., the three intermediate images in the example discussed earlier). In other words, the matrix processing module 250 generates a small droplet output image 252 from the intermediate image generated by the small droplet conversion module 220, a medium droplet output image 254 from the intermediate image generated by the medium droplet conversion module 230, and a large droplet output image 256 from the intermediate image generated by the large droplet conversion module 240. Screening herein refers to the process of applying the halftone matrix 120. FIG. 5 is a diagram illustrating an example of the halftone matrix 120.

Specifically, the small droplet output image 252 illustrated by the example in FIG. 7B is the result of applying the halftone matrix 120 to the intermediate image illustrated by the example in FIG. 7A. Herein, diagonally shaded pixels represent sites where an image is formed with small droplets. Each pixel in the intermediate image is compared against the halftone matrix 120, and in the case where a tone value in the intermediate image is greater than the threshold value in the halftone matrix 120, the pixel having that tone value is taken to be an image-forming pixel. For example, since the pixel with a tone value of 128 in the upper-left corner of the intermediate image is greater than the threshold value of 86 in the upper-left corner of the halftone matrix 120, that pixel is taken to be an image-forming pixel.

Specifically, the medium droplet output image 254 illustrated by the example in FIG. 8B is the result of applying the halftone matrix 120 to the intermediate image illustrated by the example in FIG. 8A. Herein, cross-hatched pixels represent sites where an image is formed with medium droplets. Each pixel in the intermediate image is compared against the halftone matrix 120, and in the case where a tone value in the intermediate image is greater than the threshold value in the halftone matrix, the pixel having that tone value is taken to be an image-forming pixel. For example, since the pixel with a tone value of 160 in the upper-left corner of the intermediate image is greater than the threshold value of 86 in the upper-left corner of the halftone matrix 120, that pixel is taken to be an image-forming pixel.

Specifically, the large droplet output image 256 illustrated by the example in FIG. 9B is the result of applying the halftone matrix 120 to the intermediate image illustrated by the example in FIG. 9A. Herein, smoothly shaded gray pixels represent sites where an image is formed with large droplets. Each pixel in the intermediate image is compared against the halftone matrix 120, and in the case where a tone value in the intermediate image is greater than the threshold value in the halftone matrix, the pixel having that tone value is taken to be an image-forming pixel. For example, since the pixel with a tone value of 0 in the upper-left corner of the intermediate image is less than the threshold value of 86 in the upper-left corner of the halftone matrix 120, that pixel is not taken to be an image-forming pixel.

The composition module 260 is connected to the matrix processing module 250. The composition module 260 composites the images for each droplet type screened by the matrix processing module 250 (i.e., the small droplet output image 252, the medium droplet output image 254, and the large droplet output image 256). Herein, “composition” refers to generating the image with each pixel expressed with 2 bits discussed earlier. Specifically, the output image 190 is generated by compositing the output images such that the small droplet output image 252 is taken to be “1”, the medium droplet output image 254 “2”, and the large droplet output image 256 “3”, for example. Meanwhile, pixels are not formed at positions taken to be “0”.

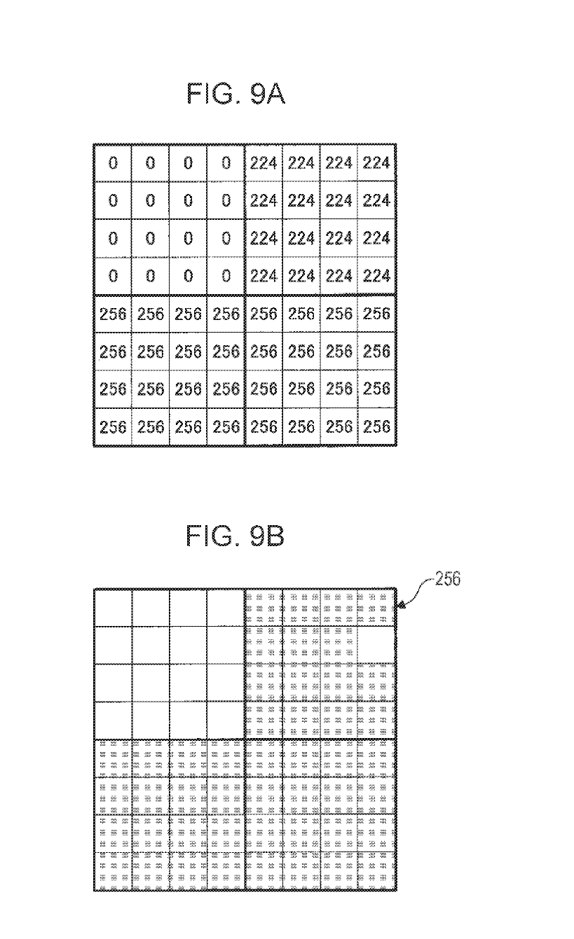

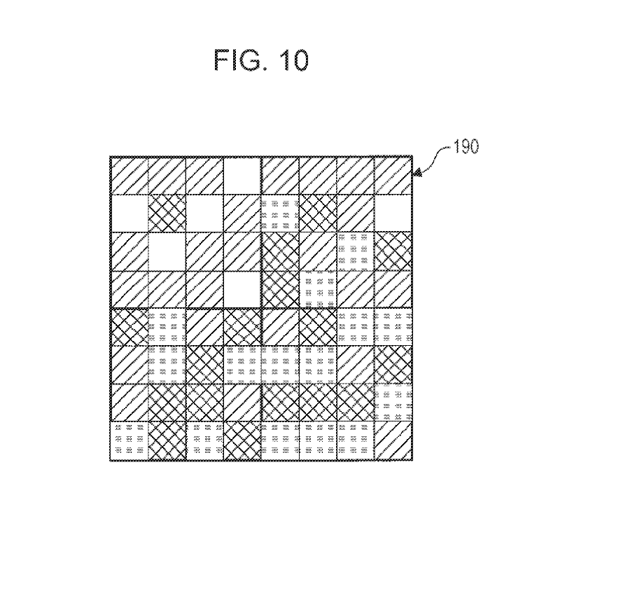

For example, the small droplet output image 252, the medium droplet output image 254, and the large droplet output image 256 may be composited to generate the output image 190. FIG. 10 is a diagram illustrating an example of the output image 190. In the case where multiple droplets (such as two or more of a small droplet, a medium droplet, and a large droplet, for example) are plotted to a single pixel, operation is conducted in accordance with the parameter 140. The output image 190 illustrated by the example in FIG. 10 is an example of the case where the droplet size selection A is applied. In other words, it is configured such that more droplets with smaller sizes are allocated to low tone values (pixel values) than other droplets. Specifically, in the case where a diagonally shaded pixel in the small droplet output image 252 (FIG. 7B) overlaps with a cross-hatched pixel in the medium droplet output image 254 (FIG. 8B) or a smoothly shaded gray pixel in the large droplet output image 256 (FIG. 9B), priority is given to the application of the pixel in the small droplet output image 252. Likewise, in the case where a cross-hatched pixel in the medium droplet output image 254 (FIG. 8B) overlaps with a smoothly shaded gray pixel in the large droplet output image 256 (FIG. 9B), priority is given to the application of the pixel in the medium droplet output image 254.

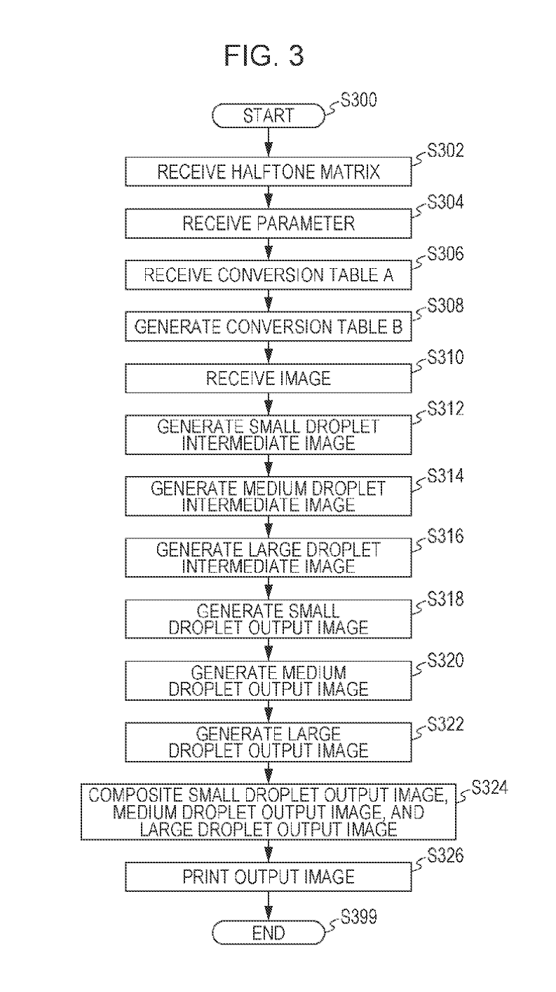

FIG. 3 is a flowchart illustrating an exemplary process according to the exemplary embodiment.

In step S302, the matrix processing module 250 receives the halftone matrix 120.

In step S304, the conversion table development module 210 receives the parameter 140.

In step S306, the conversion table development module 210 receives a conversion table A.

In step S308, the conversion table development module 210 generates a conversion table B.

In step S310, the image processing apparatus 100 receives an image 130.

In step S312, the small droplet conversion module 220 generates a small droplet intermediate image.

In step S314, the medium droplet conversion module 230 generates a medium droplet intermediate image.

In step S316, the large droplet conversion module 240 generates a large droplet intermediate image.

In step S318, the matrix processing module 250 generates a small droplet output image 252.

In step S320, the matrix processing module 250 generates a medium droplet output image 254.

In step S322, the matrix processing module 250 generates a large droplet output image 256.

In step S324, the composition module 260 composites the small droplet output image 252, the medium droplet output image 254, and the large droplet output image 256.

In step S326, the print module 150 prints the output image 190.

The processing in steps S312 to S316 may be conducted in any order or in parallel.

The processing in steps S318 to S322 may be conducted in any order or in parallel.

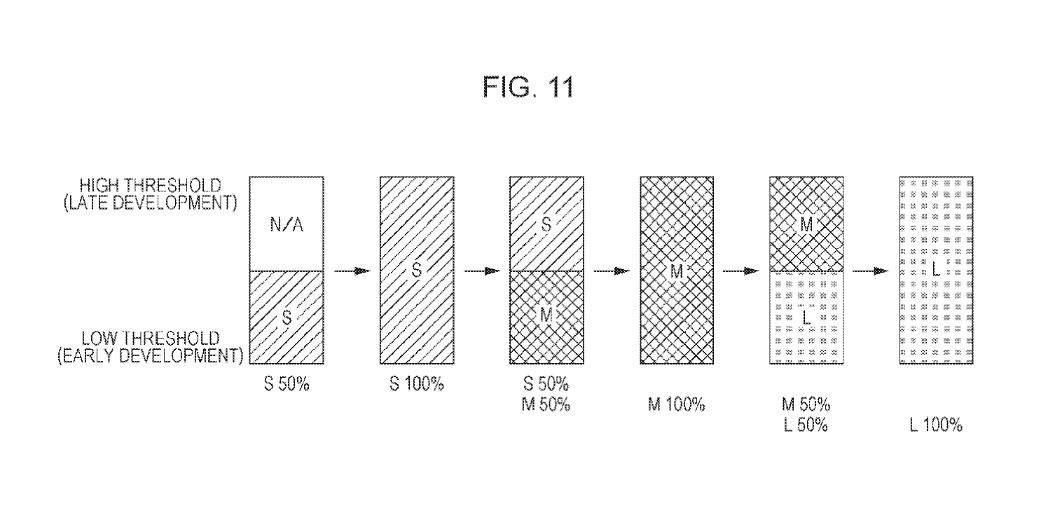

FIG. 11 is a diagram illustrating an example of combining two types of droplets according to the exemplary embodiment. FIG. 11 is an illustration of the example in FIG. 23. From left to right, FIG. 11 illustrates examples for 50% small droplets, 100% small droplets, 50% small droplets and 50% medium droplets, 100% medium droplets, 50% medium droplets and 50% large droplets, and 100% large droplets. According to the exemplary embodiment, it is also possible to configure a conversion table 110 having such a structure.

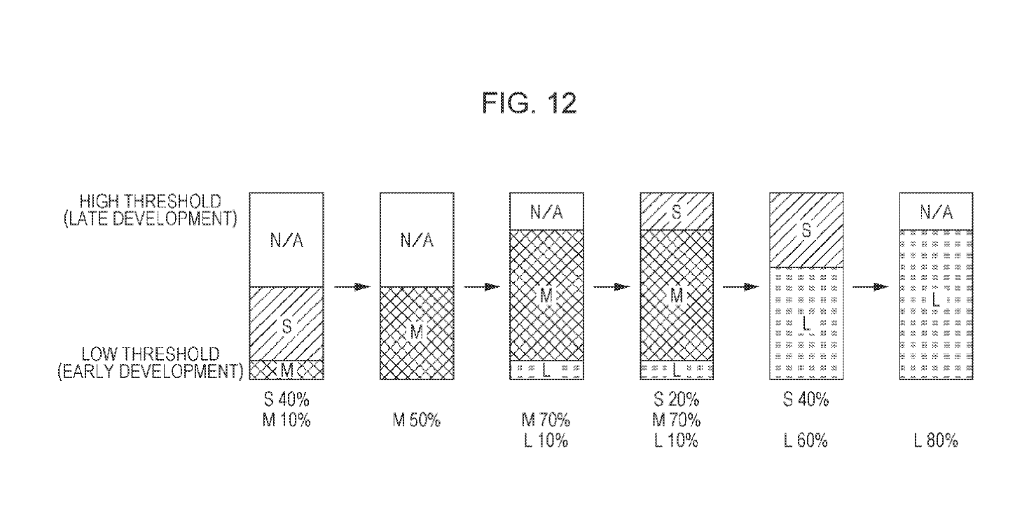

FIG. 12 is a diagram illustrating an example of combining multiple types of droplets according to the exemplary embodiment (an example of combining three types of droplets). From left to right, FIG. 12 illustrates examples for 40% small droplets and 10% medium droplets, 50% medium droplets, 70% medium droplets and 10% large droplets, 20% small droplets and 70% medium droplets and 10% large droplets, 40% small droplets and 60% large droplets, and 80% large droplets. According to the exemplary embodiment, it is also possible to configure a conversion table 110 having such a structure. Note that not only combinations of consecutive droplet types but also other combinations (such as combinations of small droplets and large droplets in the case of three types of droplets, for example) are possible, as illustrated by the example for 40% small droplets and 60% large droplets that is the second example from the right in FIG. 12.

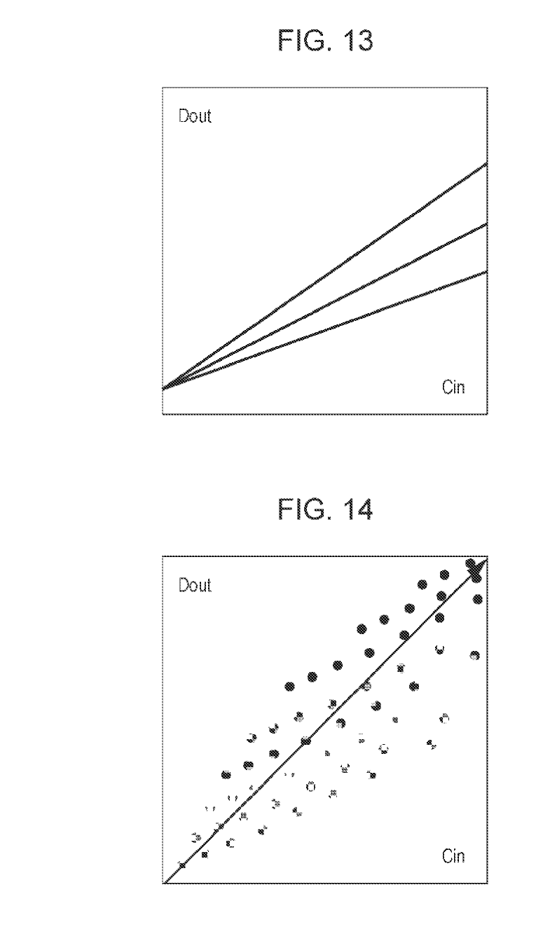

FIG. 13 is a graph illustrating exemplary changes in pixel values in the case of printing with single droplets. The horizontal axis represents pixel values in a received image while the vertical axis represents printed pixel values, with the graphed lines illustrating the relationship for large droplets, medium droplets, and small droplets in that order from the top.

FIG. 14 is a graph illustrating exemplary changes in pixel values in the case of printing with multiple types of droplets. In the exemplary embodiment, it is possible to achieve ideal tonal characteristics (such as the arrow, for example) by joining arbitrary points (the points plotted on the graph in FIG. 14) from among the combinations of multiple types of droplets.

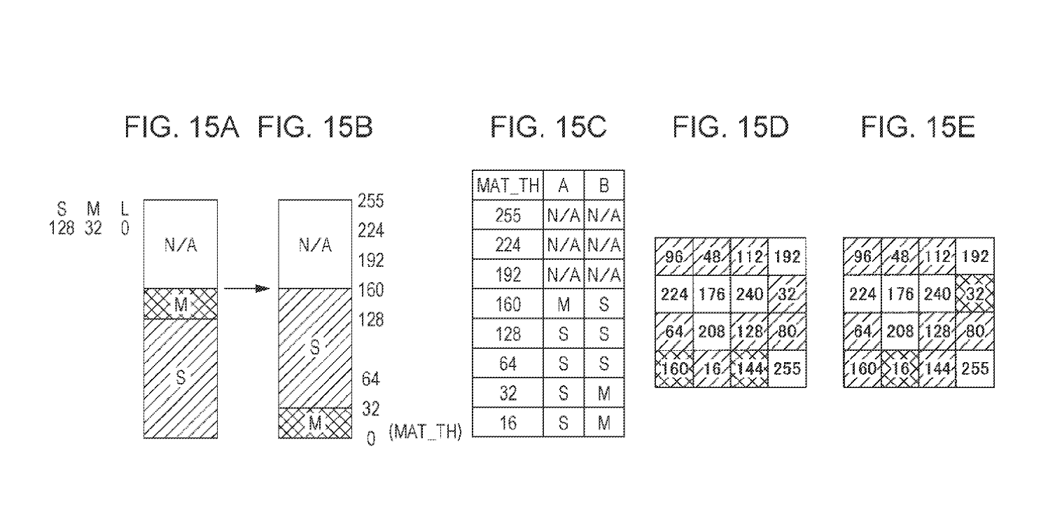

FIGS. 15A to 17E are diagrams illustrating correspondences according to different droplet size selection instructions, and exemplary image processing.

The example in FIGS. 15A to 15E takes the proportions of small, medium, and large droplets to be 128, 32, and 0, respectively.

Column A of the table illustrated by the example in FIG. 15C is equivalent to the conversion table 105 illustrated by the example in FIG. 4A. In other words, column A indicates that in the case of the droplet size selection A, small droplets are applied in the case of pixel values within a threshold from 0 to 16 inclusive, small droplets within a threshold from 17 to 32 inclusive, small droplets within a threshold from 33 to 64 inclusive, small droplets within a threshold from 65 to 128 inclusive, medium droplets within a threshold from 129 to 160 inclusive, and nothing (i.e., no image formation) for pixel values equal to or greater than a threshold value of 161.

The example in FIG. 15A illustrates the relationship between these droplet size selection A thresholds and applied droplets. In FIG. 15A, small droplets are concentrated at low pixel values in the image being processed.

Also, the example in FIG. 15D illustrates the state of applying the droplet size selection A thresholds to an image. In other words, an image is formed with small droplets for the pixel values 96, 48, 112, 32, 64, 128, 80, and 16, and with medium droplets for the pixel values 160 and 144, whereas no image is formed for the pixel values 192, 224, 176, 240, 208, and 255.

Column B of the table illustrated by the example in FIG. 15C is equivalent to the conversion table 105 illustrated by the example in FIG. 4A. In other words, column B indicates that in the case of the droplet size selection B, medium droplets are applied in the case of pixel values within a threshold from 0 to 16 inclusive, medium droplets within a threshold from 17 to 32 inclusive, small droplets within a threshold from 33 to 64 inclusive, small droplets within a threshold from 65 to 128 inclusive, small droplets within a threshold from 129 to 160 inclusive, and nothing (i.e., no image formation) for pixel values equal to or greater than a threshold value of 161.

The example in FIG. 15B illustrates the relationship between these droplet size selection B thresholds and applied droplets. In FIG. 15B, small droplets are concentrated at high pixel values in the image being processed.

Also, the example in FIG. 15E illustrates the state of applying the droplet size selection B thresholds to an image. In other words, an image is formed with small droplets for the pixel values 96, 48, 112, 64, 128, 80, 160, and 144, and with medium droplets for the pixel values 32 and 16, whereas no image is formed for the pixel values 192, 224, 176, 240, 208, and 255.

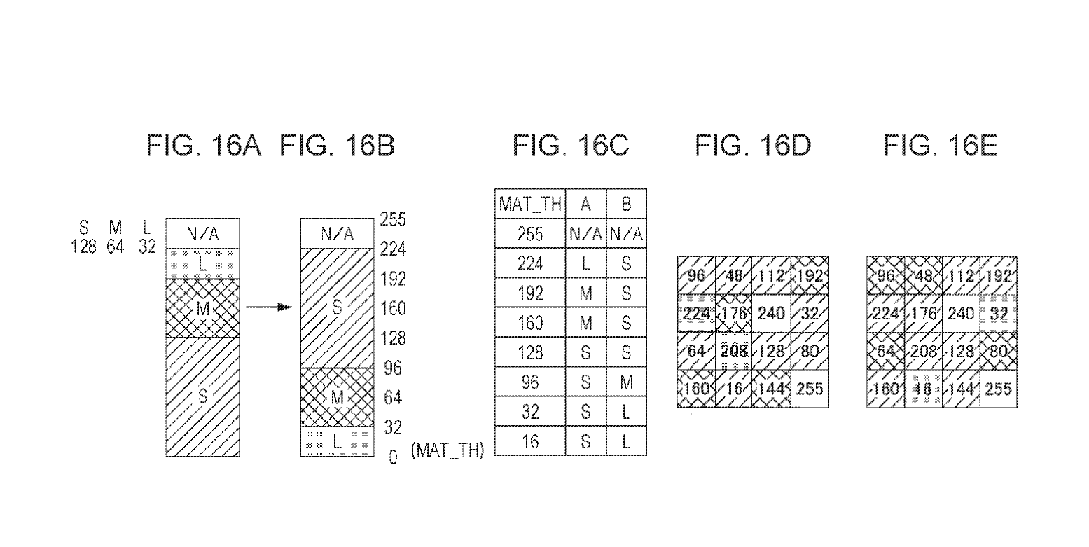

Column A of the table illustrated by the example in FIG. 16C is equivalent to the conversion table 105 illustrated by the example in FIG. 4A. In other words, column A indicates that in the case of the droplet size selection A, small droplets are applied in the case of pixel values within a threshold from 0 to 16 inclusive, small droplets within a threshold from 17 to 32 inclusive, small droplets within a threshold from 33 to 96 inclusive, small droplets within a threshold from 97 to 128 inclusive, medium droplets within a threshold from 129 to 160 inclusive, medium droplets within a threshold from 161 to 192 inclusive, large droplets within a threshold from 193 to 224 inclusive, and nothing (i.e., no image formation) for pixel values equal to or greater than a threshold value of 225.

The example in FIG. 16A illustrates the relationship between these droplet size selection A thresholds and applied droplets. In FIG. 16A, small droplets are concentrated at low pixel values in the image being processed.

Also, the example in FIG. 16D illustrates the state of applying the droplet size selection A thresholds to an image. In other words, an image is formed with small droplets for the pixel values 96, 48, 112, 32, 64, 128, 80, and 16, with medium droplets for the pixel values 192, 176, 160, and 144, and with large droplets for the pixel values 224 and 208, whereas no image is formed for the pixel values 240 and 255.

Column B of the table illustrated by the example in FIG. 16C is equivalent to the conversion table 105 illustrated by the example in FIG. 4A. In other words, column B indicates that in the case of the droplet size selection B, large droplets are applied in the case of pixel values within a threshold from 0 to 16 inclusive, large droplets within a threshold from 17 to 32 inclusive, medium droplets within a threshold from 33 to 96 inclusive, small droplets within a threshold from 97 to 128 inclusive, small droplets within a threshold from 129 to 160 inclusive, small droplets within a threshold from 161 to 192 inclusive, small droplets within a threshold from 193 to 224 inclusive, and nothing (i.e., no image formation) for pixel values equal to or greater than a threshold value of 225.

The example in FIG. 16B illustrates the relationship between these droplet size selection B thresholds and applied droplets. In FIG. 16B, small droplets are concentrated at high pixel values in the image being processed.

Also, the example in FIG. 16E illustrates the state of applying the droplet size selection B thresholds to an image. In other words, an image is formed with small droplets for the pixel values 112, 192, 224, 176, 208, 128, 160, and 144, with medium droplets for the pixel values 96, 48, 64, and 80, and with large droplets for the pixel values 32 and 16, whereas no image is formed for the pixel values 240 and 255.

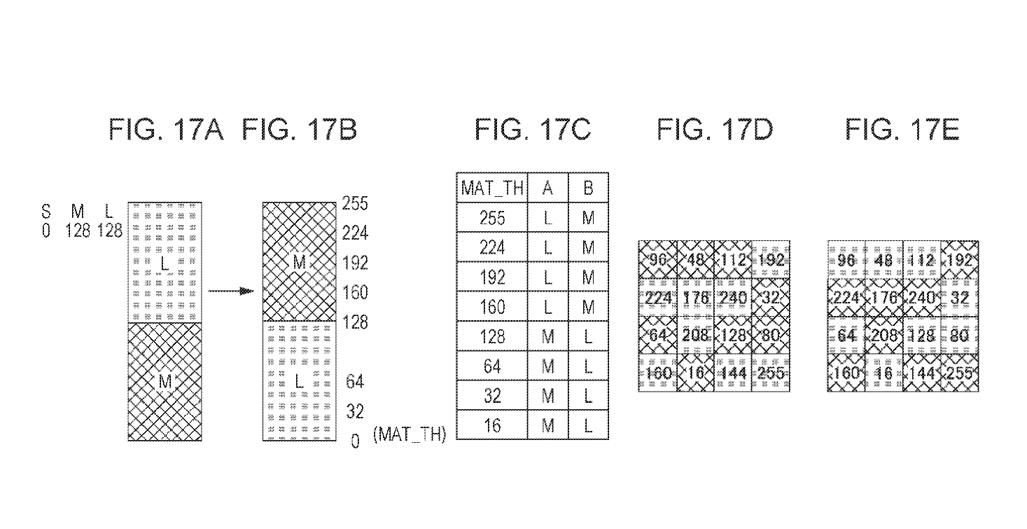

Column A of the table illustrated by the example in FIG. 17C is equivalent to the conversion table 105 illustrated by the example in FIG. 4A. In other words, column A indicates that in the case of the droplet size selection A, medium droplets are applied in the case of pixel values within a threshold from 0 to 16 inclusive, medium droplets within a threshold from 17 to 32 inclusive, medium droplets within a threshold from 33 to 64 inclusive, medium droplets within a threshold from 65 to 128 inclusive, large droplets within a threshold from 129 to 160 inclusive, large droplets within a threshold from 161 to 192 inclusive, large droplets within a threshold from 193 to 224 inclusive, and large droplets within a threshold from 225 to 255 inclusive.

The example in FIG. 17A illustrates the relationship between these droplet size selection A thresholds and applied droplets. In FIG. 17A, medium droplets are concentrated at low pixel values in the image being processed.

Also, the example in FIG. 17D illustrates the state of applying the droplet size selection A thresholds to an image. In other words, an image is formed with medium droplets for the pixel values 96, 48, 112, 32, 64, 128, 80, and 16, and with large droplets for the pixel values 192, 224, 176, 240, 208, 160, 144, and 255.

Column B of the table illustrated by the example in FIG. 17C is equivalent to the conversion table 105 illustrated by the example in FIG. 4A. In other words, column B indicates that in the case of the droplet size selection B, large droplets are applied in the case of pixel values within a threshold from 0 to 16 inclusive, large droplets within a threshold from 17 to 32 inclusive, large droplets within a threshold from 33 to 64 inclusive, large droplets within a threshold from 65 to 128 inclusive, medium droplets within a threshold from 129 to 160 inclusive, medium droplets within a threshold from 161 to 192 inclusive, medium droplets within a threshold from 193 to 224 inclusive, and medium droplets within a threshold from 225 to 255 inclusive.

The example in FIG. 17B illustrates the relationship between these droplet size selection B thresholds and applied droplets. In FIG. 17B, medium droplets are concentrated at high pixel values in the image being processed.

Also, the example in FIG. 17E illustrates the state of applying the droplet size selection B thresholds to an image. In other words, an image is formed with medium droplets for the pixel values 192, 224, 176, 240, 208, 160, 144, and 255, and with large droplets for the pixel values 96, 48, 112, 32, 64, 128, 80, and 16.

In the exemplary embodiment, although there are 256 possible droplet size distribution patterns for Cin values from 0 to 255, the halftone matrix threshold values applied to an image are shared across all cases, and thus a single halftone matrix is sufficient, even if the number of tones or number of droplet sizes N increases. While the number of intermediate images to process increases as the number of droplet sizes N increases, the number of intermediate images does not increase even if the tone bit depth increases.

Furthermore, 2,829,056 combinations are possible, without being limited to the example in FIG. 24. Note that there are only 768 combinations in the related art.

Using this technique, droplet distributions may be arbitrarily determined for N types of droplets. Whereas in the related art the droplet distribution is predetermined as in the example of FIG. 11, in the exemplary embodiment all kinds of combinations are possible as in the example of FIG. 12. Accordingly, it is possible to obtain tone characteristics like those illustrated by the example in FIG. 14.

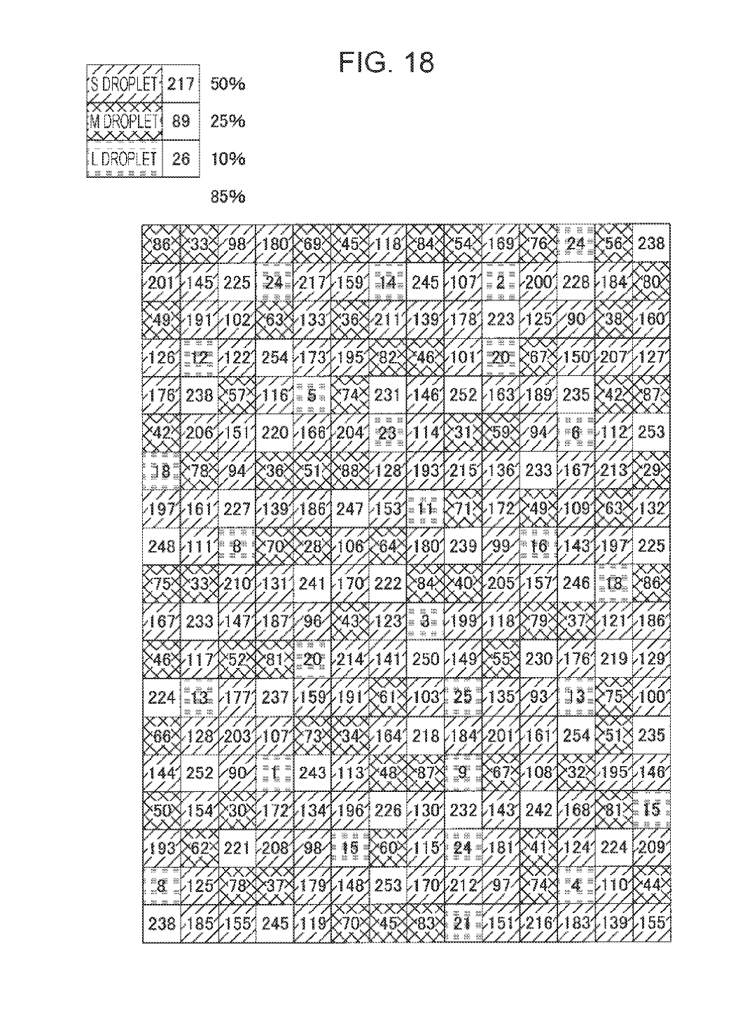

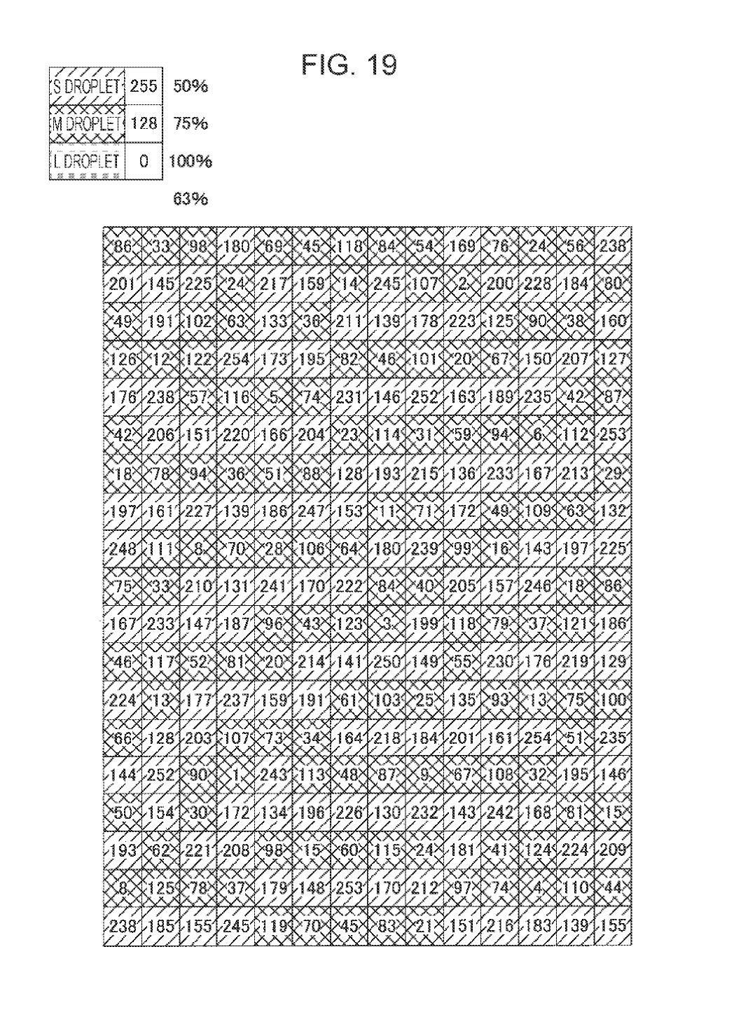

FIG. 18 is a diagram illustrating an example for the case of expressing an image with three types of droplets and arbitrary tone balance according to the exemplary embodiment. FIG. 19 is a diagram illustrating an example for the case of expressing an image with two types of droplets. In the related art, there is a tendency for the same types of droplets to concentrate in regions of close density, as in the example in FIG. 19. If the same types of droplets become concentrated, streaks become more noticeable. In contrast, with the exemplary embodiment, it is possible to output N types of droplets at the same densities, there making it easier to disperse the same types of droplets and reduce streaks, as in the example in FIG. 18.

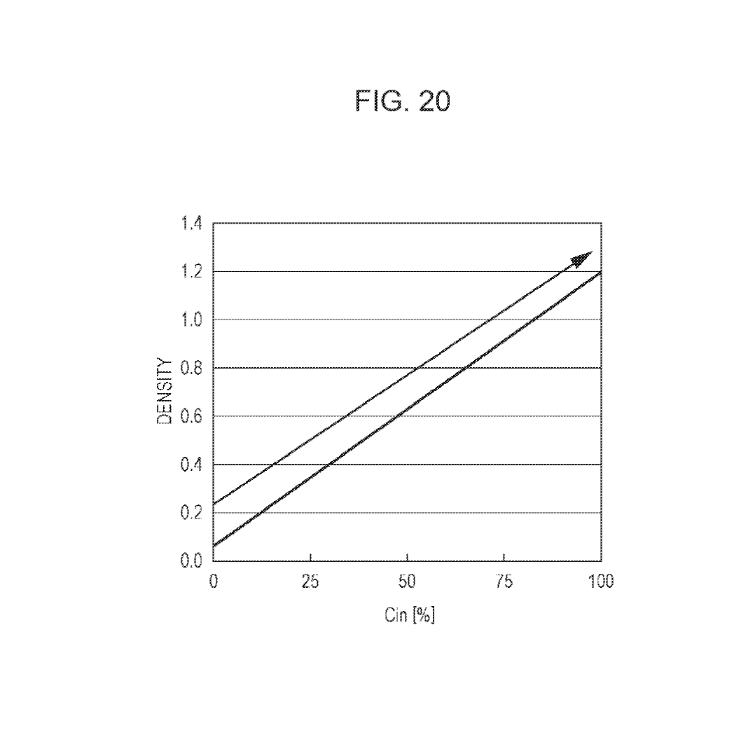

FIG. 20 is a graph illustrating exemplary changes in pixel values according to the exemplary embodiment. Unlike the example in FIG. 27, a tone curve (the linearly rising graph) is realized without producing a tone jump or tone loss when switching dots due to tone differentiation among respective droplets.

Although the exemplary embodiment discussed above illustrates the example of three types of droplets, an exemplary embodiment may also be applied to four or more types of droplets.

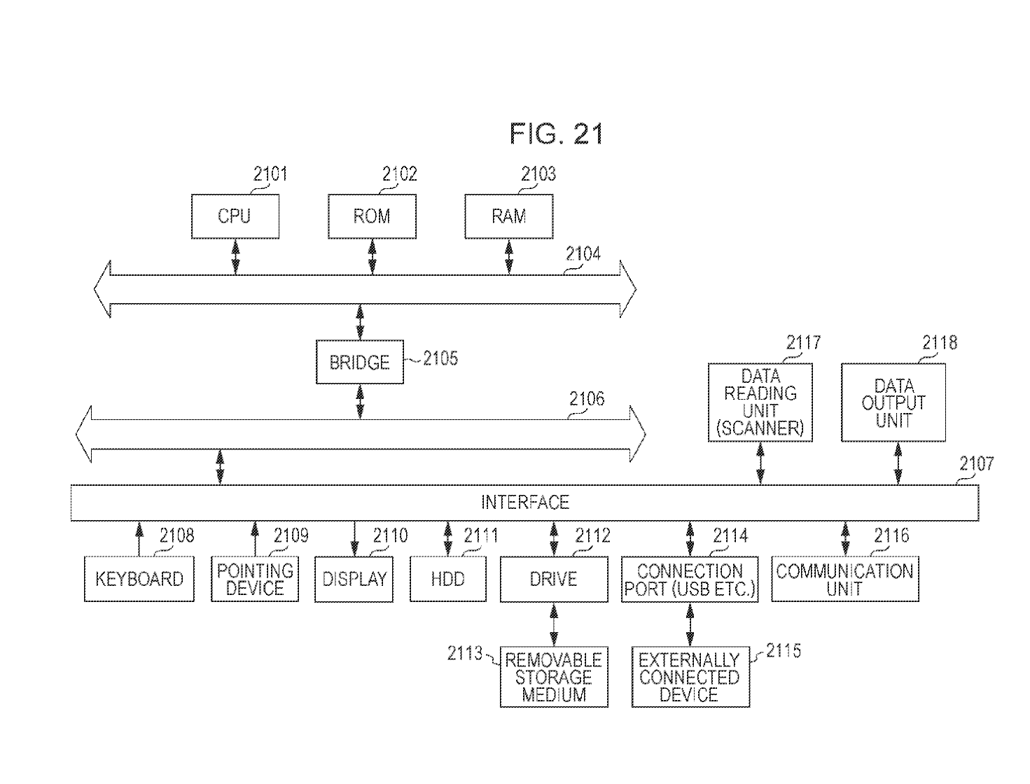

An exemplary hardware configuration of an image processing apparatus according to the exemplary embodiment will now be described with reference to FIG. 21. The configuration illustrated in FIG. 21 may be realized by a personal computer (PC), for example, and illustrates an exemplary hardware configuration equipped with a data reading unit 2117 such as a scanner, and a data output unit 2118 such as a printer.

The central processing unit (CPU) 2101 is a controller that executes a process in accordance with a computer program that states execution sequences for the various modules described in the exemplary embodiment discussed in the foregoing, or in other words, for respective modules such as the image processing apparatus 100, the print module 150, the conversion table development module 210, the small droplet conversion module 220, the medium droplet conversion module 230, the large droplet conversion module 240, the matrix processing module 250, and the composition module 260.

The read-only memory (ROM) 2102 stores information such as programs and computational parameters to be used by the CPU 2101. The random access memory (RAM) 2103 stores information such as programs to be used during execution by the CPU 2101, and parameters that change as appropriate during such execution. These memory units are connected to each other by a host bus 2104 realized by a CPU bus, for example.

The host bus 2104 is connected to an external bus 2106 such as a Peripheral Component Interconnect/Interface (PCI) bus via a bridge 2105.

The keyboard 2108 and the mouse or other pointing device 2109 are input devices operated by a user. The display 2110 may be a liquid crystal display (LCD) or cathode ray tube (CRT) device, and displays various information as text and image information.

The hard disk drive (HDD) 2111 houses and drives a hard disk, causing programs executed by the CPU 2101 and information to be recorded thereto or retrieved therefrom. Information such as a received image 130, conversion table 110, halftone matrix 120, and parameter 140 are stored in the hard disk. Additionally, various other computer programs such as various data processing programs are stored therein.

The drive 2112 reads out data or programs recorded onto a removable recording medium 2113 such as an inserted magnetic disk, optical disc, magneto-optical disc, or semiconductor memory, and supplies the data or programs to the RAM 2103 connected via the interface 2107, the external bus 2106, the bridge 2105, and the host bus 2104. The removable recording medium 2113 is usable as a data recording area similar to a hard disk.

The connection port 2114 is a port that connects to an externally connected device 2115, and has a USB, IEEE 1394, or similar receptacle. The connection port 2114 is connected to the CPU 2101 and other units via the interface 2107 as well as the external bus 2106, the bridge 2105, and the host bus 2104, for example. The communication unit 2116 is connected to a communication link and executes data communication processing with external equipment. The data reading unit 2117 may be a scanner, for example, and executes document scanning processing. The data output unit 2118 may be a printer, for example, and executes document data output processing.

Note that the hardware configuration of an image processing apparatus illustrated in FIG. 21 illustrates a single exemplary configuration, and that the exemplary embodiment is not limited to the configuration illustrated in FIG. 21 insofar as the configuration still enables execution of the modules described in the exemplary embodiment. For example, some modules may also be realized with special-purpose hardware (such as an application-specific integrated circuit (ASIC), for example), and some modules may be configured to reside within an external system and be connected via a communication link. Furthermore, it may also be configured such that multiple instances of the system illustrated in FIG. 21 are connected to each other by a communication link and operate in conjunction with each other. Additionally, the image processing apparatus may also be incorporated in devices such as a photocopier, fax machine, scanner, printer, or multi-function device (i.e., an image processing apparatus having two or more from among scanning, printing, copying, and faxing functions).

Note that the described program may be provided stored in a recording medium, but the program may also be provided via a communication medium. In this case, a computer-readable recording medium storing a program, for example, may also be taken to be an exemplary embodiment of the present invention with respect to the described program.

A “computer-readable recording medium storing a program” refers to a computer-readable recording medium upon which a program is recorded, and which is used in order to install, execute, and distribute the program, for example.

Potential examples of a recording medium include a digital versatile disc (DVD), encompassing formats such as DVD-R, DVD-RW, and DVD-RAM defined by the DVD Forum and formats such as DVD+R and DVD+RW defined by DVD+RW Alliance, a compact disc (CD), encompassing formats such as read-only memory (CD-ROM), CD Recordable (CD-R), and CD Rewritable (CD-RW), a Blu-ray Disc®, a magneto-optical (MO) disc, a flexible disk (FD), magnetic tape, a hard disk, read-only memory (ROM), electrically erasable and programmable read-only memory (EEPROM®), flash memory, random access memory (RAM), and a Secure Digital (SD) memory card.

In addition, all or part of the above program may also be recorded to the recording medium and saved or distributed, for example. Also, all or part of the above program may be communicated by being transmitted using a transmission medium such as a wired or wireless communication network used in a local area network (LAN), a metropolitan area network (MAN), a wide area network (WAN), the Internet, an intranet, an extranet, or some combination thereof, or alternatively, by being impressed onto a carrier wave and propagated.

Furthermore, the above program may be part of another program, and may also be recorded to a recording medium together with other separate programs. The above program may also be recorded in a split manner across multiple recording media. The above program may also be recorded compressed, encrypted, or in any other recoverable form.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
memory that stores first pixel values in association with second pixel values for respective droplets which have been classified into a plurality of types according to size;
one or more converters that convert pixel values in a received image, which correspond to the first pixel values, into second pixel values to generate an image for each of the respective droplet types, on the basis of the correspondences between the first pixel values and the second pixel values stored in the memory;
a screening unit that screens the images for the respective droplet types converted by the one or more converters; and
a compositing unit that composites the images for the respective droplet types screened by the screening unit.

2. The image processing apparatus according to claim 1, further comprising:
a correspondence generator that generates correspondences between the first pixel values and the second pixel values from values indicating the proportion of each droplet type to use with respect to the first pixel values, and stores the generated correspondences in the memory.

3. The image processing apparatus according to claim 2, wherein
the correspondence generator receives a variable indicating whether or not to allocate more droplets with smaller sizes than other droplets with respect to low pixel values in the received image, and generates correspondences between the first pixel values and the second pixel values in accordance with the variable.

4. The image processing apparatus according to claim 2, wherein
the correspondence generator receives a variable indicating whether or not to allocate more droplets with smaller sizes than other droplets with respect to high pixel values in the received image, and generates correspondences between the first pixel values and the second pixel values in accordance with the variable.

5. An image processing method comprising:
storing first pixel values in association with second pixel values for respective droplets which have been classified into a plurality of types according to size;
converting pixel values in a received image, which correspond to the first pixel values, into second pixel values to generate an image for each of the respective droplet types, on the basis of the stored correspondences between the first pixel values and the second pixel values;
screening the converted images for the respective droplet types; and
compositing the screened images for the respective droplet types.

6. A program causing a computer to execute a process for processing an image, the process comprising:
storing first pixel values in association with second pixel values for respective droplets which have been classified into a plurality of types according to size;
converting pixel values in a received image, which correspond to the first pixel values, into second pixel values to generate an image for each of the respective droplet types, on the basis of the stored correspondences between the first pixel values and the second pixel values;
screening the converted images for the respective droplet types; and
compositing the screened images for the respective droplet types.
